(19) United States
(12) Patent Application Publication
(10) Pub. No.: US 2005/0204730 A1
(43) Pub. Date: Sep. 22, 2005

(54) Engine with a charging system

(76) Inventors: Kojyu Tsukahara, Hamamatsu-shi (JP); Shigeyuki Ozawa, Hamamatsu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/080,109

(22) Filed: Mar. 15, 2005

(30) Foreign Application Priority Data
Mar. 16, 2004 (JP) 2004-074214

(51) Int. Cl. F02N 17/00; F01N 3/00

(52) U.S. Cl. 60/290

(57) ABSTRACT

An engine has a charging system in which pressurized air is supplied to an intake side of the engine through an intake air passage. An induction passage branches and extends from the middle of the intake air passage and is provided with a control valve. The induction passage is in communication with an exhaust passage. The induction passage supplies secondary air to the exhaust passage through the control valve to treat the engine's exhaust gas.

### PRIORITY INFORMATION

This application is based on and claims priority to Japanese Patent Application No. 2004-074214, filed Mar. 16, 2004, the entire contents of which is hereby expressly incorporated by reference.

### BACKGROUND OF THE INVENTIONS

1. Field of the Inventions

The present application generally relates to engines with charging systems, and more particularly to engines with charging systems that mix intake air with exhaust gases.

2. Description of the Related Art

Vehicles, including personal watercraft and jet boats, are often powered by an internal combustion engine having a supercharger or turbocharger in order to increase engine power output. Japanese Patent Application HEI 11-99992 discloses using a supercharger turbocharger to enhance the performance of a watercraft engine. Superchargers or turbochargers are often used with engines having relatively small displacements. Some of these conventional engines have systems for purifying exhaust gas.

Exhaust gas typically contains combustion by-products (including unburned hazardous substances) that must be removed or treated before the gas is discharged from certain vehicles. Thus, exhaust gas is often treated and purified before it is expelled.

Often, ambient air is supplied to an exhaust passage in an engine and mixed with the exhaust gas. Such systems are typically referred to as 3-way catalyst systems, and may be capable of treating and reducing the combustion by-products by an oxidation process. The combustion by-products can include hazardous substances, such as carbon oxide (CO), hydrocarbons (HC), and nitrogen oxides (NOx). The air and these substances can react with oxygen in air to form less hazardous substances.

Unfortunately, for the exhaust gas to be purified by a 3-way catalyst in this manner, a large amount of catalyst air is required, typically resulting in an increased engine size. In addition, when air is supplied into the exhaust side of the engine, the air may be at a lower pressure as compared to the pressure of the exhaust gas. Thus, the air may not adequately enter the exhaust system of the engine, especially when the exhaust pressure is raised during high engine speeds, thus resulting in unsatisfactory purification of the exhaust gas.

Pumps can be used to pressurize air supplied to an engine's exhaust passage. For example, Japanese Patent Application HEI 07-026946 discloses a pressurization pump that supplies air to an exhaust passage. Unfortunately, these pumps further complicate engine design and increase engine size and weight.

For example, such pumps can complicate the control mechanisms for controlling the output of the engine and operation of the pump, resulting in a higher engine cost. Additionally, pressurized air provided by a pump, which is independent of the supercharger or turbocharger, can make it difficult to achieve the desired air fuel ratio by throttle control, fuel injection control, ignition timing control, and/or the like. Accordingly, it can be very difficult to obtain a desired catalytic effect while obtaining the desired engine output.

### SUMMARY OF THE INVENTIONS

An aspect of at least one of the embodiments disclosed herein includes the realization that an exhaust treatment system can be simplified by using a supercharger or turbocharger as an air supply device. For example, a turbo charger or supercharger can be connected to an engine so as to provide compressed air for combustion in the engine. Some of the compressed air from the turbocharger or supercharger can be diverted to the exhaust system for catalytic treatment. This provides an advantage in that there is no need for a separate device for pressurizing air for injection into the exhaust system.

In accordance with an embodiment, an engine comprises a charging system configured to pressurize air to a pressure above atmospheric pressure. An air intake passage extends between the charging system and an intake side of the engine and between the charging system and an exhaust passage of an exhaust side of the engine. An induction passage extends from the air intake passage and includes a control valve system. The control valve system is positioned to deliver air pressured by the charging system to the exhaust passage.

In accordance with another embodiment, an engine comprises an exhaust side and an intake side. A charging system is configured to pressurize secondary air to a pressure greater than atmospheric pressure. An air intake passage is positioned to receive pressurized air from the charging system and includes an induction passage and a secondary passage. The secondary passage is positioned to deliver secondary air to the exhaust side of the engine and the induction passage is positioned to deliver air the intake side of the engine. A control valve is positioned along the induction passage and is configured to selectively control the flow of secondary air into the exhaust side of the engine.

### BRIEF DESCRIPTION OF THE DRAWINGS

The above-mentioned and other features of the inventions disclosed herein are described below with reference to the drawings of the preferred embodiments. The illustrated embodiments are intended to illustrate, but not to limit the inventions. The drawings contain the following Figures:

FIG. 1 is a side elevational view of a personal watercraft powered by an engine having a charging system in accordance with certain features, aspects, and advantages disclosed herein. Several of the internal components of the personal watercraft (e.g., the engine) are illustrated in phantom.

FIG. 2 is a schematic illustration of the engine showing a charging system in accordance with an embodiment.

FIG. 3 is a schematic illustration of a modification of the engine of FIG. 2.

FIG. 4 is a schematic illustration of another modification of the engine.

FIG. 5 is a graph showing exemplary reference values that can be used for the control of a valve system of an engine having the charging systems of FIGS. 2-4.

### DETAILED DESCRIPTION OF THE PREFERRED EMBODIMENT

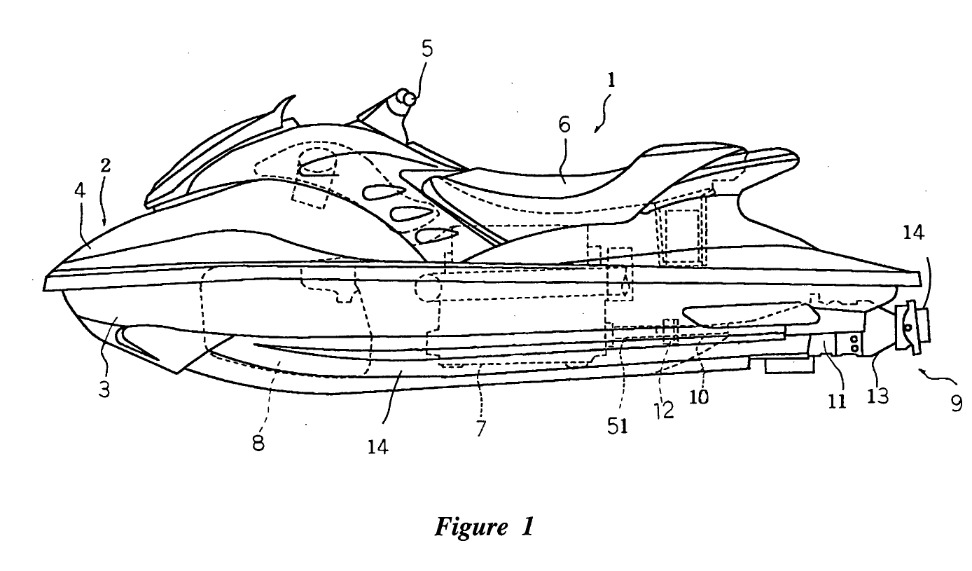

With reference to FIG. 1, an overall configuration of a personal watercraft 1 and its engine 7 is described below. The described engine has particular utility for use within the personal watercraft, and thus, it is described in the context of personal watercraft. However, the engine can also be applied to other types of vehicles, such as small jet boats and other vehicles that feature marine drives, automobiles, motorcycles, scooters, and the like, as well as industrial stationary engines, generators, and other engines, for example.

The watercraft 1 has a body 2 that includes an upper hull section 4 and a lower hull section 3. The upper and lower hull sections 3, 4 cooperate to define an internal cavity that can form an engine compartment 14. The engine compartment 14 can be defined by a forward and rearward bulkhead, however, other configurations are also possible. The engine compartment 14 is preferably located under a seat 6, but other locations are also possible (e.g., beneath the control mast or the bow).

The watercraft 1 also includes handlebars 5 in front of the seat 6 and on top of the upper hull section 4. The seat 6 is preferably positioned centrally along the body 2 and on the upper side of the upper hull section 4. Additionally, foot mounting steps can be formed at the sides of the body 2. Preferably one foot mounting step is on the left side and another foot mounting step is on the right side of the seat 6. The seat 6 has a saddle shape, so that a rider can sit on the seat 6 in a straddle fashion and is often is referred to as a straddle-type seat; however, other types of seats can also be employed.

The engine 7 is disposed within the engine compartment 14 defined by the body 2. Thus, a rider can access the engine 7 in the illustrated arrangement by detaching the seat 6 from the body 2.

In some embodiments, including the illustrated embodiment, the engine 7 is mounted inside the body 2 below and somewhat forwardly from the seat 6. A fuel tank 8 can be positioned in front of the engine 7. The rearward lower surface (on the stern side) of the lower hull section 3 can be raised upwardly from the bottom toward the inside of the body 2 to form a downwardly concaved portion, preferably extending laterally centrally of the body 2 in the longitudinal direction to the end of the stern.

A jet pump unit 9 can be driven by the engine 7 to propel the illustrated watercraft 1. An impeller shaft 10 can extend between a crankshaft 51 of the engine 7 and the jet pump unit 9. In the illustrated embodiment, a coupling member 12 is positioned between the impeller shaft 10 and the crankshaft 51. The crankshaft 51 imparts rotary motion to the impeller shaft 10 which, in turn, drives the pump unit 9.

The jet pump unit 9 can be disposed within a tunnel formed on the underside of the lower hull section 3. The jet pump unit 9 preferably comprises a discharge nozzle 13 and a steering nozzle 14 to provide steering action. The steering nozzle 14 can be pivotally mounted about a generally vertical steering axis. The jet pump unit 9 can be connected to the handlebars 5 by a cable or other suitable arrangement so that a rider can pivot the steering nozzle 14 for steering the watercraft 1. Other types of marine drives can also be used to propel the watercraft 1 depending upon the application.

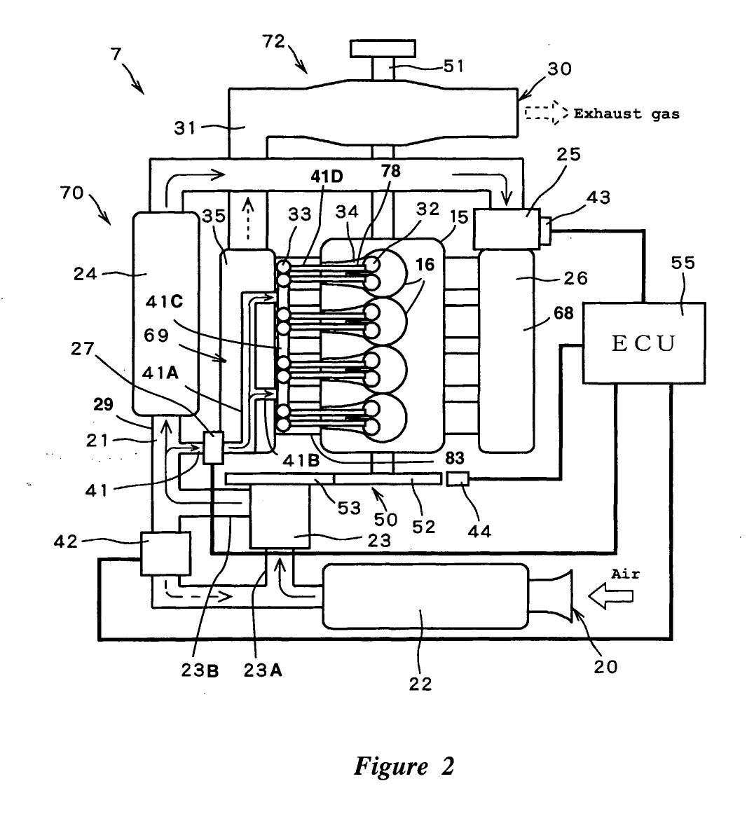

With reference to FIGS. 1-4, the engine 7 can be a multi-cylinder type internal combustion engine. The arrows in FIGS. 2-4 indicate flows of gases (e.g., secondary air and exhaust gas) through the engine. The engine 7 of FIG. 2 has an air intake system 70 and an exhaust system 72.

With reference to FIG. 2, the engine 7 includes a cylinder block 15 with four aligned cylinder bores 16. The illustrated engine, however, merely exemplifies one type of engine which can have an embodiment of the present charging system. Engines having a different number of cylinders, other cylinder arrangements, various cylinder orientations (e.g., upright cylinder banks, V-type, and W-type), and operating on various combustion principles (e.g., four stroke, crankcase compression two-stroke, diesel, and rotary) are all practicable for use with the charging systems disclosed herein. An exhaust line of each cylinder 16 can be in communication with at least one exhaust passage, such as the exhaust passage 31.

As described below, the air intake system 70 includes a charging system 23 that can provide pressurized air to the cylinders 16. The pressurized air results in more air/fuel mixture that be squeezed into each cylinder during engine operation to increase engine performance, as compared to normally aspirated engines. As used herein, the term “pressurized” is intended to mean air that is pressurized to a pressure greater than atmospheric pressure.

As noted above, the charging system 23 is configured to pressurize air. The air intake system 70 can deliver pressurized air from the charging system 23 to the engine cylinders. A portion of the pressurized air is delivered to the intake side 68 of the engine 7. Another portion of the pressurized air is delivered to the exhaust side 69 of the engine 7, so that the this pressurized air can be sent to the exhaust passage 31 through a control valve system 27 and mixed with exhaust gas. This pressurized air can be referred to as “secondary” air.

The secondary pressurized air mixing with the exhaust gas enhances an oxidization process, which helps to purify the exhaust gases. That is, the secondary air aids the oxidization process that preferably reduces the concentration of hazardous substances in the exhaust gas outputted from the engine cylinders 16. The purified gas mixture (e.g., the exhaust gas and the air from the charging system 23) can be discharged out of an exhaust outlet 30 into the body of water in which the watercraft 1 is located, or to the atmosphere.

In the illustrated embodiment, the engine 7 can intake ambient air mix it with fuel and/or exhaust gases for cleaning the exhaust gases produced by the combustion process. Air introduced to the engine 7 can be directed through an air intake inlet 20 and an air cleaning system 22. The air can then delivered through a charging inlet 23A and to the charging system 23.

As used herein, the term “charging system” is a broad term in use in its ordinary meaning and includes, without limitation, a forced induction system, air pressurization system, and the like suitable for providing pressurized air, also often referred to as “boost”. The terms “charging systems” and “charger systems” are used interchangeably herein.

The charging system 23 of FIG. 2 is in the form of a supercharger. As used herein, the term “supercharger” is a broad term in use in its ordinary meaning and includes, without limitation, mechanical-type superchargers for internal combustion engines. For example, the supercharger can be a mechanically-driven centrifugal supercharger, mechanically-driven positive displacement supercharger, pressure-wave supercharger, and the like. The illustrated supercharger 23 is a mechanical supercharger that is configured to compress fluid (e.g., air) using power supplied by at least one component of the engine 7.

The supercharger 23 can be driven by the rotation of the crankshaft 51 through a charging drive system 50, which comprises a plurality of gears 52, 53. Although not illustrated, the supercharger 23 can be driven by the charging drive system 50 that comprises a belt/chain drive system. In view of the present disclosure, a skilled artisan can select the type and design of the charging system and charging drive system based on the overall configuration and application of the engine. The supercharger 23 can pressurize air and deliver the pressurized air to the supercharger outlet 23B, which, in turn, delivers the air to downstream components of the air intake system 70.

Such a mechanical type supercharger 23 connected to the crankshaft 51 is reliably driven during engine rotation, even at low engine speeds. Thus, irrespective of the magnitude of the rotational speed of the engine 7, air can be continuously supplied to the exhaust side 69 of the engine. Thus, the supercharger 23 can deliver air to the air intake system 70 and secondary air to the exhaust side 69 of the engine 7 when the engine 7 operates at any operating condition.

The air intake passage 21 of the air intake system 70 receives air from the supercharger 23 and delivers, preferably simultaneously, air to the engine cylinders 16 and the secondary air to the exhaust system 72. The air intake passage 21 can branch into one or more sub passageways. The illustrated air intake passage 21 can be divided so as to branch into an induction passage 41 and an intercooler passage 29.

The air pressurized by the supercharger 23 within the air intake passage 21 can be divided into one or more flows, preferably one of the flows passing through the induction passage 41 to the exhaust system 72 and another flow passing through the intercooler passage 29 and eventually to the engine cylinders 16. By diverting air from the charging system 23 to the exhaust system 72 from a point upstream of the intercooler, a further advantage is achieved in that this air is not cooled before being introduced into the exhaust system. For example, the components of the exhaust system 72 can be relatively hot during operation. If the secondary air was cooled before contacting exhausts system components, undesirable thermal stresses might be generated. However, by diverting secondary air from the charging system 23 from a point upstream from the intercooler 24, the air is at a higher temperature due to the compression by the charging system 72, thereby reducing the thermal stresses that might result.

The induction passage 41 is preferably smaller in size than the air intake passage 21 and preferably extends from the branching point of the air intake passageway 21 to the control valve system 27. The intercooler passage 29 extends from a branching point of the air intake passage 21 to an intercooler 24.

The air delivered to the intercooler 24 can be delivered to the intake manifold 26, which can deliver the air to each of the cylinders 16 of the engine 7. The intercooler 24 can decrease or increase the temperature of the air delivered by the intercooler passage 29. For example, the intercooler 24 can reduce a temperature of the pressurized air, thereby reducing the air pressure to produce increased intake air efficiency. For example, the intercooler 24 can be cooled by utilizing water, such as the water in which the watercraft 1 operates, to effectively cool the air passing through the intercooler 24. The intercooler 24 can help compensate for the loss of density, which can be caused by energy of compression, turbulence in the air flow through the supercharger, and/or heat transferred from the supercharger. Because the intercooler 24 increases the density of the air, a higher power output can be achieved with the engine 70.

Additionally, lower temperatures in the engine can reduce the thermal loading and increase fuel efficiency. The inner cooler 24 can be a heat exchanger that employs air-to-water cooling. However, the intercooler 24 can also be an air-to-air cooler. In such an embodiment, the intercooler can use cool ambient air to reduce the temperature of the air passing through the air intake passage 21. In view of the present disclosure, a skilled artisan can select the design and configuration of the intercooler 24 to achieve the desired cooling effect.

The amount of air supplied to the intake manifold 26 can be controlled by the throttle 25. The throttle 25 can be used to selectively control the flow of air from the intercooler 24 to the intake manifold 26. The settings of the throttle 25 can be based on the desired operation of the engine 7. For example, a user=operable throttle lever can be used to control the opening amount of the throttle 25.

The air which passes through the induction passage 41 is supplied to the exhaust side 69 of the engine through the control valve system 27 and can be mixed with exhaust gas output from the engine cylinders. Preferably, hydrocarbon and carbon monoxide components in the exhaust gas can be removed by an oxidation reaction with oxygen (O₂) in the air that is supplied to the exhaust system from the air induction system. The exhaust side 69 includes the exhaust system 70 that receives exhaust gas from the engine cylinders 16 and discharges it from the engine 7.

The induction passage 41 is preferably configured to deliver secondary air to a position near an exhaust valve 32. In some embodiments, the induction passage 41 includes a main passage 41A, branched passages 41B, a secondary air manifold 41C, and connecting passages 41D. The main passage 41A extends from the junction of the air intake passage 21 to the branched passages 41B. The illustrated induction passage 41 has a pair of passages 41B. However, the induction passage 41 can have any suitable number of passages 41B. For example, the induction passage 41 can branch into more than two passages 41B. Alternative, the induction passage 41 may not be branched and can extend from the air intake passage 21 to the secondary air manifold 41C.

The passages 41B are connected to the secondary air manifold 41C. The secondary air manifold 41C delivers the secondary air to the connecting passages 41D. The connecting passages 41D extend from the secondary air manifold 41C to a position near the seat of the exhaust valves 32. In some embodiments, a pair of connecting passages 41D is connected to a corresponding engine cylinder 16.

Secondary air can pass from the air intake passage 21 to the induction passage 41. The secondary air can then proceed along the main passage 41A through the valve 27 to the passages 41B. The secondary airflow is divided and delivered to the secondary air manifold 41C. The manifold 41C can have optional reed valves 33 for preventing backflow in the air induction passage 41. The secondary air then flows through the optional reed valves 33 to the connecting passages 41D and to the exhaust valves 32. In some embodiments, the connecting passages 41D are positioned through corresponding exhaust ports 34. The secondary air and exhaust gas can be mixed proximate to the exhaust valve 32. The mixed gas is then delivered through the exhaust runners 83 of the exhaust system 70 to the exhaust manifold 35.

The valve system 27 can selectively control the flow of gas from the induction passage 41 to the exhaust side 69 of the engine. The opening and closing of the valve system 27 can be based upon a program or map. The valve system 27 can comprise one or more valves suitable for controlling fluid flow. For example, the control valve system 27 can comprise one or more needle valves, gate valves, solenoid valve system, or other suitable valve system for controlling the flow of air through the induction passage 41. The illustrated the control valve system 27 is positioned along a central portion of the induction passage 41.

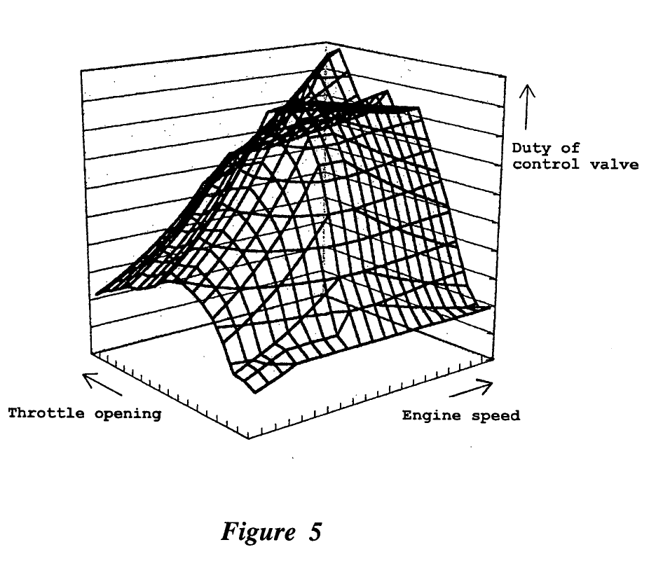

The valve system 27 is optionally opened and closed based on a map shown in FIG. 5, which can vary between the engines shown in FIGS. 2-4. The map shows the duty of the control valve operation based upon the engine speed and throttle opening, although other variable can also be used. The illustrated map can be prepared based on responses of the engine speed detected by an engine speed sensor 44, the throttle opening detected by a throttle sensor 43, and/or supercharging pressure or boost. The opening/closing of the valve system 27 can be controlled by an ECU 55, preferably based on the duty ratio obtained from a map such as the map of FIG. 5.

A skilled artisan can determine an appropriate map for an engine based on the type of engine and/or the purpose of the engine. The map can be adjusted such that the purification of exhaust gas, the engine output, or other parameter is given different weight than the other parameters. In some embodiments, the engine output may be the most important parameter, thus the valve system 27 may be substantially or completely closed when a relatively large engine speed or throttle opening is detected.

The supercharger 23 is driven by the crankshaft 51, such that air can be supplied to the exhaust side 69 during various operating conditions of the engine 7. For example, the crankshaft 51 can drive the supercharger 23 even at relatively low engine speeds, preferably irrespective of the rotational speed of the engine 7. Thus, secondary air is supplied through the passages 21 and 41 during any engine operating conditions.

As noted above, valves 33 can be provided near the downstream end 78 of the induction passage 41 to prevent backflow of the exhaust gas into the induction passage 41. The valves 33 can be reed valves or any other suitable valves (e.g., check valves) or valve systems for preventing backflow of the exhaust gas. Although the reed valves 33 are not necessary, without such valves, exhaust gas as hot as 700° C.-800° C. may flow into the induction passage 41 when the pressure of exhaust gas is higher than that of air supplied from the supercharger 23. The induction passage 41 and the control valve 27 can comprise high heat resistance materials due to these high operating temperatures.

Air supplied to the exhaust passage 31 from the control valve 27 is mixed with exhaust gas and discharged from the exhaust outlet 30 at the rear end of a muffler (not shown) located at the end of the exhaust passage 31. In some embodiments, the secondary pressurized air and exhaust gas are combined before diffusion of the exhaust gas discharged from the exhaust valve 32 in order to effectively mix these gases. Preferably the end 78 of the induction passage 41 is positioned near to the exhaust valve 32 to enhance gas mixing. In the illustrated embodiment of FIG. 2, the induction passage 41 is connected, through the reed valves 33, to connecting portions between the exhaust ports 34 of the two exhaust valves 32 in each cylinder of the four-cylinder engine and the exhaust manifold 35.

In one advantageous embodiment, the ECU 55 is configured to control operation or the engine 7. The ECU 55 is preferably a microcomputer that includes a microcontroller having a CPU, a timer, RAM, and/or ROM. Of course, other suitable configurations of ECU 55 can also be used. Preferably, the ECU 55 is configured with or capable of accessing various maps (such as the map of FIG. 5) to control one or more components of the engine. The ECU 55 can be in communication with one or more of the following: the throttle sensor 43, the engine speed sensor 44, valve system 27, and the blow-off valve 42.

When the supercharger 23 pressurizes air to a pressure above a predetermined pressure, the valve 42, which can be in the form of a blow-off valve, is opened to reduce the air pressure in the air intake passage 21. The air from the blow-off valve 42 can optionally then be delivered to the supercharger 23 and can be subsequently pressurized. The blow-off valve 42 can be a mechanical valve (e.g., a valve actuated by a spring). In some embodiments, the blow-off valve is a solenoid valve (preferably opened/closed by the ECU 55). One or more pressure sensors can be provided in the intake air intake passage 21 on the downstream side from the superchargers 23, and operation of the valve can be based on feedback from the sensor(s). The valve 42 can be any suitable pressure-relief or pressure-reducing valve suitable for reducing the pressure in the air intake system 70 a desired amount.

In the foregoing arrangement, the detection value of each sensor is sent to the ECU 55 and the opening and closing of the control valve 27 is controlled by a means programmed in the ECU 55, based on these measured values.

In the example shown in FIG. 2, although the exhaust system 73 is delivered airflow controlled by one control valve 27, a plurality of control valves 27 may be employed. For example, a control valve can correspond to each cylinder for individual control. Alternatively, a control valve may be provided each pair of cylinders.

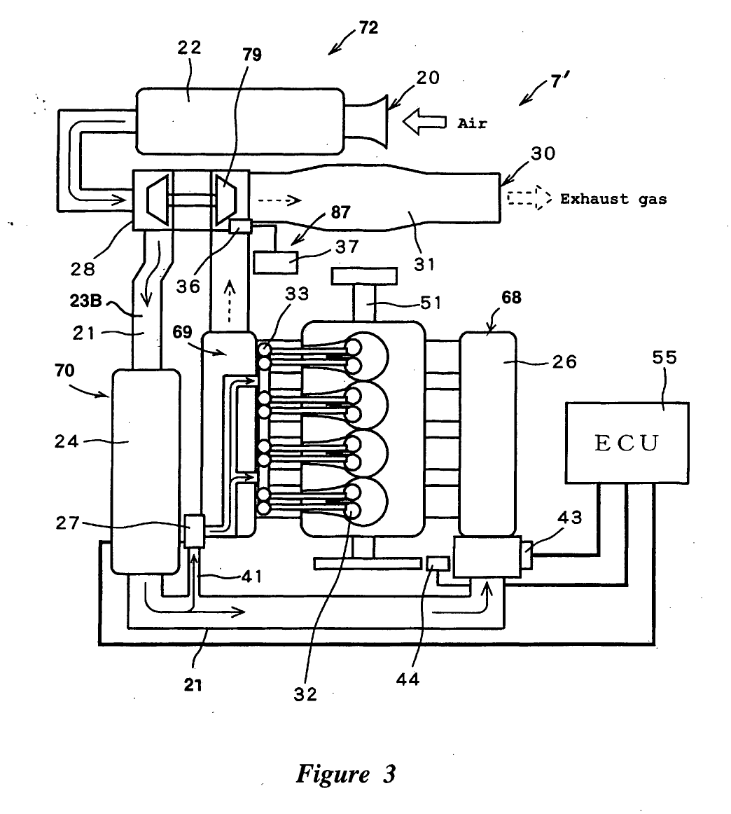

FIG. 3 illustrates a modification of the engine 7, and is identified generally with the reference numeral 7′. The engine 7′ is generally similar to the engine 7 of FIG. 2, except as further detailed below. Where possible, similar elements are identified with identical reference numerals in the depiction of the embodiment of FIG. 2.

The engine 7′ includes a charging system 28 in the form of a turbocharger that can be used under various operating conditions. As used herein, the term “turbocharger” is a broad term in use in its ordinary meaning and includes, without limitation, exhaust gas turbochargers for internal combustion engines.

The map of FIG. 5 can be modified to take into account various characteristics of the turbocharger 28 to obtain an optimum amount of secondary air efficiently supplied in response to the engine speed, engine load, and/or the like. For example, if the turbocharger 28 is powered solely by the engine's exhaust gases when the engine operates at low speeds, the turbine 79 may achieve low rotational speeds resulting in a low amount of generated energy. In some circumstances, this may result in the turbocharger 28 supplying relatively low amounts of pressured air at lower pressures.

However, when the engine operates in a high speed range, the turbocharger 28 is driven by a relatively high flow rate of high pressured exhaust gas. The air introduced from the intake air inlet 20, which passes through the air cleaner 22, is pressurized by the turbocharger 28, which is driven by the exhaust gas. This pressurized air output from the turbocharger 28 is then supplied to the intake side 68 of the engine so that the desired engine output is obtained. The map of FIG. 5 takes into account these various characteristics of the turbocharger 28.

With continued reference to FIG. 3, the turbocharger 28 delivers pressurized air the air intake system 70. The air passes through the supercharger outlet 23B to the intercooler 24 which, in turn, delivers the air to the air intake passage 21. The air intake passage 21 divides the air flow into one or more air flows. In the illustrated embodiment, the intake passage 21 is downstream of the intercooler 24. The intake passage 21 also divides airflow and delivers an airflow into the induction passage 41 extending from a central portion of the air intake passage 21. The airflow in the induction passage 41 is delivered to the valve system 27 and mixed with the exhaust gas, as discussed above with reference to the embodiment of FIG. 2.

With reference again to FIG. 2, the induction passage 41 branches from the air intake passage 21 at a point upstream of the intercooler 24, and the pressurized air from the supercharger 23 is supplied directly into the exhaust side 69 of the engine 7. In the illustrated embodiment of FIG. 2, the exhaust gas can be oxidized easily because the secondary air temperature is relatively high. In the embodiment shown in FIG. 3, on the other hand, the induction passage 41 is branched downstream of the intercooler 24 in which case the cooled air, with a relatively high density, is supplied as secondary air to the exhaust side 69 of the engine 7′. The valve system 27 can deliver a sufficient amount of oxygen for effective oxidation and purification of the exhaust gas. That is, the engines 7, 7′ may mix different amounts of secondary air with the exhaust gas to achieve the desired oxidation process.

With continued reference to FIG. 3, the turbocharger 28 can include a turbine 79 and a compressor 60, preferably installed on a shaft 61. In some embodiments, the turbine 79 continues its rotation due to inertial forces even after the throttle is closed. This turbine rotation can cause the turbocharger 28 to raise the pressure of the secondary air an undesirable amount.

To control the turbocharger pressure, a bypass system 87 can be configured to control the pressure in the exhaust side of the engine 7′. The bypass system 87 can include a bypass valve 36 and an actuator 37 that can cooperate to adjust the exhaust gas pressure upstream of the turbine 79. Thus, the bypass valve 36 and the actuator 37 are located at the exhaust side entrance of the turbocharger 28. If the pressure of the intake manifold 26 is negative, or an abrupt change of the throttle opening as detected (e.g., closing of the throttle opening), for example, the actuator 37 is operated to partially or fully open the bypass valve 36 in order to reduce the flow of exhaust gas to the turbine 79. In this manner, the rotation of the turbine 79 can be decreased or stopped as desired. The bypass valve 36 can be positioned at any point along the exhaust flow path, preferably downstream of the turbocharger 28. It is contemplated that the bypass valve 36 can be similar or different than the valve 42 of FIG. 2.

Excess air can also be vented from the engine 7′ when the pressure exceeds a predetermined amount. For example, if the pressure within the air intake passage 21 reaches a predetermined value, a optional valve (e.g., a pressure-relief valve, bypass valve or blow off valve, etc.) located along the air intake passage 21 can relieve the pressure within the passage 21, and thus may protect against compressor surges and/or excessive pressures. It is contemplated that one or more of these valves can be employed in the engines disclosed herein.

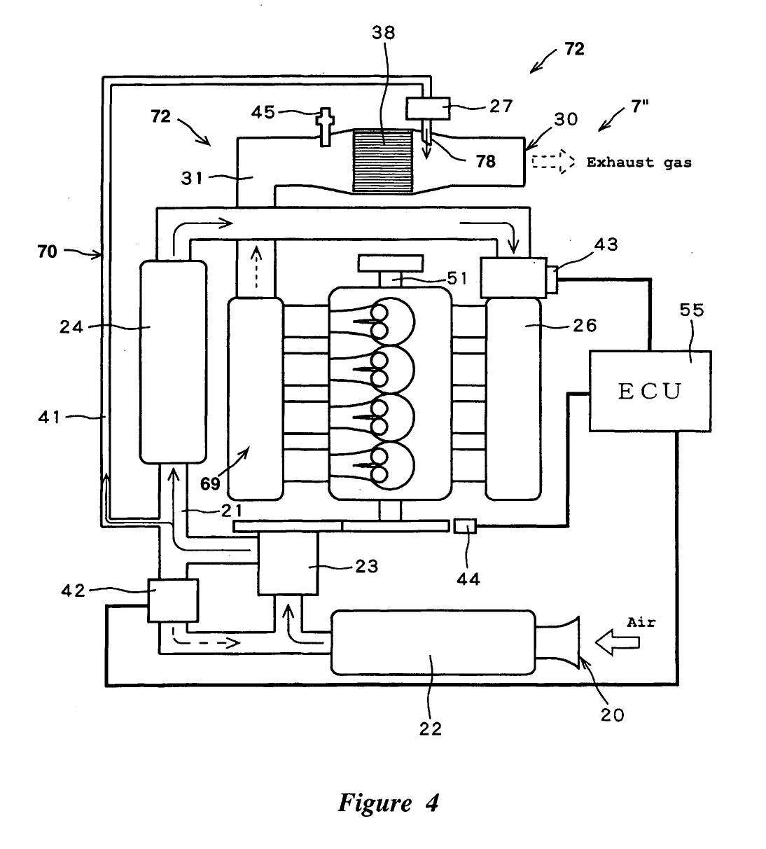

With reference to FIG. 4, another modification of the engine 7 is illustrated therein and identified generally by the reference numeral 7′. The engine 7″ can be similar to the engine 7 illustrated in FIG. 2, except as detailed below. The components of the engine 7″ are identified with the same reference numerals as those used to identify corresponding components of the engine 7 of FIG. 2.

The engine 7″ has an exhaust side 69 that includes a catalyst configured and positioned to further purify exhaust gas produced by the engine 7. In the illustrated embodiment, the catalyst 38 is used in combination with the charging system 23 and is positioned along the exhaust passage 31, preferably along a central portion of the passage 31. The catalyst 38 can be a catalytic converter (preferably three-way catalytic converter) for treating, by oxidation and reduction, one or more hazardous substances, such as CO, HC, NOx, typically found in exhaust gases. To enhance the performance of the catalyst 38, a sensor 45 (such as, for example, but without limitation, an oxygen sensor) can be positioned upstream of the catalyst 38 to measure and analyze the exhaust gas sent to the catalyst 38. Based on these measurements, approximate theoretical desired air fuel ratios can be determined based one or more of the following: desired purification of the exhaust gas, engine performance, fuel efficiency, and the like.

To further enhance purity of the exhaust gas, the air intake system 70 delivers secondary air to the exhaust side 69 of the engine 7″. The intake system 70 delivers secondary air at some point downstream of the catalyst 38 and before the exhaust gas is emitted from the exhaust outlet 30. However, the intake system 70 can deliver secondary air at any suitable point along the exhaust side 69 of the engine 7″, such as at a point along the exhaust side 69 of the engine 7″ upstream of the catalyst 38.

The intake system 70 includes the induction passage 41 that extends from the air intake passage 21 to a position downstream of the catalyst 38. The upstream end of the induction passage 41 is connected to the air intake passage 21 and the downstream end 78 of the induction passage 41 is in communication and connected to the exhaust passage 31. The downstream end 78 of the induction passage 41 is positioned along the exhaust passage 31 at some point downstream of the catalyst 38.

The exhaust gas air fuel ratio is controlled by a theoretical air fuel ratio determined by the ECU 55, preferably based on feedback from the sensor 45, which can be an oxygen sensor, or other type of senor.

The catalyst 38 treats the exhaust gas to reduce the amount of hazardous substances in the exhaust gas passed out of the exhaust outlet 30. In exemplary embodiments, the catalyst 38 can be a one-way catalytic converter, a two-way catalytic converter, a three-way catalytic converter, or other suitable device for treating the exhaust gas.

With continued reference to FIG. 4, pressurized air from the supercharger 23 can flow through the passage 21, the induction passage 41, and into the exhaust passage 31 so that it is mixed with exhaust gas that has just passed out of the catalyst 38. In other words, air, which preferably has high amounts of oxygen, is passed through the passage 41 and mixed with the hazardous substances in the exhaust gas for an oxidation reaction so that the exhaust gas is further purified before it is discharged out of the exhaust outlet 30. The size of the catalyst 38 can be relatively small because the unburned exhaust gas from the catalyst 38 is being treated with secondary air, thus the overall engine size can be reduced. The catalyst 38 and second air work in combination to effectively treat the exhaust gas. Advantageously, the emissions from the engine 7″ can be effectively controlled at a relatively low cost due to the simplicity of the design.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

1. An engine comprising a charging system configured to pressurize air to a pressure above atmospheric pressure, an air intake passage extending between the charging system and an intake side of the engine and between the charging system and an exhaust passage of an exhaust side of the engine, an induction passage extending from the air intake passage and including a control valve system, the control valve system being positioned to deliver air pressured by the charging system to the exhaust passage.

2. The engine of claim 1, wherein the control valve system is configured to selectively control air flow into the exhaust passage in response to at least one of engine speed, a throttle opening, air pressure achieved by the charging system.

3. The engine of claim 1, wherein the charging system comprises a supercharger driven by a crankshaft of the engine.

4. The engine of claim 1, wherein the charging system comprises a turbocharger driven by exhaust gas outputted by the engine.

5. The engine of claim 1, wherein a downstream end of the induction passage is in communication with the exhaust passage near an exhaust valve of the engine.

6. The engine of claim 1, wherein a catalytic converter configured to treat exhaust gas is disposed along the exhaust passage, and the induction passage is in communication with the exhaust passage on a downstream side of and near the catalytic converter.

7. The engine of claim 1, wherein the control valve system is configured to move to a substantially closed position when a change in engine speed exceeds a predetermined rate of increase or when a throttle opening exceeds a predetermined value for a predetermined period of time.

8. The engine of claim 7, wherein the control valve system is configured such that air is not supplied to the exhaust passage when the control valve system is substantially closed.

9. The engine of claim 9, wherein the air intake passage is branched to form the induction passage and a second passage, the second passage being positioned to deliver air to the intake side of the engine.

10. The engine of claim 9, wherein a junction of the induction passage and the second passage is upstream of an intercooler device, along a direction of air flow into the engine.

11. The engine of claim 1, wherein a portion of the air intake passage extending between the charging system and the exhaust system is connected to connects to another portion of the air intake passage downstream of an intercooler device.

12. An engine comprising an exhaust side and an intake side, a charging system configured to pressurize secondary air to a pressure greater than atmospheric pressure, an air intake passage being positioned to receive pressurized air from the charging system and having an induction passage and a secondary passage, the secondary passage positioned to deliver secondary air to the exhaust side of the engine and the induction passage positioned to deliver air the intake side of the engine, a control valve positioned along the induction passage and configured to selectively control the flow of secondary air into the exhaust side of the engine.

13. The engine of claim 12, wherein the exhaust side of the engine includes an exhaust passage, the secondary air and exhaust gas mix in an exhaust system.

14. The engine of claim 12, wherein the intake side of the engine is configured to deliver pressurized air to engine cylinders for a combustion process and the exhaust side of the engine is configured to receive combustion byproducts from the engine cylinders.
